(19) United States
(12) Patent Application Publication
(10) Pub. No.: US 2013/0277199 A1
(43) Pub. Date: Oct. 24, 2013

(54) Solar-Driven Air Gap Membrane Distillation System

(71) Applicant: Massachusetts Institute of Technology, Cambridge, MA (US)

(72) Inventors: Edward Kurt Summers, Cambridge, MA (US); Ryan Enright, Whitestone, NY (US); John H. Lienhard, Lexington, MA (US)

(21) Appl. No.: 13/858,194

(22) Filed: Apr. 8, 2013

Related U.S. Application Data
(60) Provisional application No. 61/625,716, filed on Apr. 18, 2012.

(51) Int. Cl. B01D 61/36

(52) U.S. Cl. CPC B01D 61/364
USPC 202/234

(57) ABSTRACT

Membrane distillation system. The system includes a solar radiation absorbing porous membrane positioned to receive solar radiation to heat the membrane. A transparent cover is spaced apart from the membrane to form a channel through which a saline feed stream flows. A condensation structure is spaced apart from an opposite side of the porous membrane forming an air gap channel there between. Means are provided for coolant flow along an outside surface of the condensation structure so that distilled water will condense on the condensation structure for collection from the air gap channel.

This application claims priority to provisional application Ser. No. 61/625,716 filed Apr. 18, 2012, the contents of which are incorporated herein by reference.

### BACKGROUND OF THE INVENTION

This invention relates to desalination and more particularly to a thermal based membrane distillation technology capable of treating highly concentrated or contaminated brines with a thermal efficiency that is nearly twice that of known solar powered membrane distillation systems.

Solar powered desalination has the potential to provide a solution for arid, water-scarce regions that also benefit from sunny climates, but which are not connected to municipal water and power distribution networks that are necessary for the implementation of efficient, large-scale desalination systems. Solar energy can provide heating energy or electrical power to a small scale system that could run independent of any other infrastructure.

The most common form of solar desalination is a solar still. Solar stills are simple to build, but inherently do not recycle energy as water condenses on a surface that rejects heat to the ambient environment [1]. Another option of this type is solar powered reverse osmosis. While more energy efficient than any thermal based system, it requires expensive components and is expensive to maintain. RO membranes experience high pressures and can easily be damaged by substances commonly found in seawater, therefore pretreatment is required. High cost and complexity make these systems unattractive for off-grid or developing world applications.

Membrane distillation (MD) has several advantages as a means for desalination and water purification. As a thermally driven membrane technology which runs at relatively low pressure, which can withstand high salinity feed streams, and which is potentially more resistant to fouling, MD can be used for desalination where reverse osmosis is not a good option. The use of thermal energy, rather than electrical energy, and the fact that MD membranes can withstand dryout make this technology attractive for renewable power applications where input energy and water production would be inherently intermittent and large quantities of electricity (from photovoltaic cells) would be very expensive. The easy scalability give it advantages over other large thermal systems such as multi-stage flash and multi-effect distillation for small scale production.

However, renewable-powered MD systems which have been built currently have poor energy efficiency. When measured by the gained output ratio (GOR) these systems do not exceed the performance of a simple solar still, which typically has a GOR of 1, as most solar stills do not usually employ energy recovery [2]. GOR is the ratio of the latent heat of evaporation of a unit mass of product water to the amount of energy used by a desalination system to produce that unit mass of product. The higher the GOR, the better the performance. Systems with poor energy performance are generally costlier to run, especially if there is a large capital cost associated with solar collection [3]. Table 1 summarizes the energy performance of existing renewable-powered MD systems.

TABLE 1
GOR and operating conditions of existing renewable powered MD
desalination systems. Operating conditions listed.

| System | Type | GOR | Operating Condition |
|---|---|---|---|
| Banat et al. | AGMD | 0.9 | Clear sky, 40.11 kWh/day absorbed |
| (2007) [4] | | | energy, 7 m² memb. area |
| Fath et al. (2008) | AGMD | 0.97 | Clear sky, T [symbol] = 60-70° C. 7 m² area, |
| [5] | | | T [symbol] = 40-50° C. 0.14 kg/sec low rate, |
| | | | Seawater |
| Guillen-Burrieza | AGMD | 0.8 | T top = 80° C. [symbol] , 20.1 L/min |
| et al. (2011)[6] | | | (0.33 kg/s) feed flow rate, 5.6 m² |
| | | | memb, area, 2 modules in series, |
| | | | 35,000 PPM feed salinity |
| Wang et al. | VMD | 0.85 | |
| (2009) [7] | | | |

[symbol]

indicates data missing or illegible when filed

Of all the systems above, air gap MD (AGMD) is the simplest. The heat recovery mechanism is integrated into the module and desalination is achieved with a single flow loop. The air gap between the feed and condensate stream limits heat loss. However current renewable powered systems use large solar collector arrays which can be very expensive, as they contain not only a solar absorbing surface and glass covers, but piping and other structure as well. If this could be further integrated, a complete desalination system could be provided in a single piece of equipment with one pump for fluid circulation thereby reducing capital and resultant water cost.

### SUMMARY OF THE INVENTION

The membrane distillation system of the invention includes a solar radiation absorbing porous membrane positioned to receive solar radiation to heat the membrane. A transparent cover is spaced apart from the membrane to form a channel through which a saline feed stream flows. A condensation structure spaced apart from an opposite side of the porous membrane forms an air gap channel therebetween. Means are provided for coolant flow along an outside surface of the condensation structure whereby distilled water will condense on the condensation structure for collection from the air gap channel.

In a preferred embodiment, the membrane is dyed to enhance solar absorption. The membrane may be a composite structure of a hydrophilic polymer disposed on a membrane material. A suitable membrane material is PTFE (Teflon). The transparent cover may comprise double glazing with a vacuum in between.

Yet another embodiment includes a recovery heat exchanger to heat the feed stream and improve overall efficiency.

### BRIEF DESCRIPTION OF THE DRAWING

FIG. 1 is a schematic illustration of the radiatively heated MD module disclosed herein showing energy and mass flows.

FIG. 2 is a side view of the system disclosed herein using Fresnel mirrors to concentrate solar energy.

FIG. 3 is a schematic illustration of the hot side of the MB membrane receiving heat flux.

FIG. 4 is a graph of transmisivity versus wavelength showing transmisivity of solar collector glass compared to water in the visible and near infrared spectrum.

FIG. 5 is a schematic illustration showing loss modes through the solar collecting surface of the module.

FIG. 6 is a diagram of a basic desalination cycle using only an AGMD module.

FIG. 7 is a schematic illustration of the desalination unit disclosed herein along with a recovery heat exchanger at the bottom of the cycle.

FIG. 8 is a graph of feed side membrane temperature versus distance in the flow direction showing the temperature profile of the feed side of the membrane along the collector length with and without recovery at an insolation of one sun.

FIG. 9 is a graph of GOR versus traction of one sun showing the GOR as a function of the degree of solar concentration with and without regeneration.

### DESCRIPTION OF THE PREFERRED EMBODIMENT

In the novel configuration disclosed herein, integration of the heat collection and desalination steps is accomplished by using an MD membrane to absorb solar energy. Instead of a fluid stream being heated and sent to the beginning of the MD module at an elevated temperature, the saline fluid stream is heated directly at the point of evaporation by solar energy absorbed by the MD membrane. FIG. 1 shows the heat and mass flows along a length of membrane.

With reference to FIG. 1, a membrane distillation system 10 disclosed herein includes a radiation absorbing membrane 12 that may be dyed to provide suitable solar energy absorption. A glass cover 14 is spaced apart from the membrane 12 forming a feed stream channel 16. The channel 16 will guide a saline feed 18 along the membrane 12. Uniform heat flux 20 impinges upon and heats the radiation absorbing membrane 12.

Spaced apart from the radiation absorbing membrane 12 is a condensate structure 22 forming an air gap between the membrane 12 and the condensate structure 22. A coolant 24 passes along an outer surface of the condensate structure 22.

In operation, solar energy, for example from a Fresnel concentrator 26 as shown in FIG. 2 passes through the transparent cover 14 and through the saline feed 18 to impinge upon and heat the radiation absorbing membrane 12. The heated membrane 12 facilitates the evaporation of the saline feed which passes through the porous radiation absorbing membrane 12 into the air gap. The water vapor then condenses on the condensate structure 22 and is thereafter collected as understood in the art.

This configuration 10 has several distinct advantages over traditional MD systems. First, since the feed 18 is being continuously heated while it distills instead of being heated before being distilled, the temperature across the module remains higher, increasing the vapor pressure and the resultant flux due to higher evaporation potential. Secondly, since the heat of vaporization is being provided directly at the liquid-vapor interface, but directly from the heat source, the resistance to heat flow through the boundary layer is substantially reduced. Lastly, the entire MD process is now integrated in one device 10 and can take advantage of simple methods of solar collection and concentration, such as using a Fresnel mirror array 26 as shown in FIG. 2.

Some aspects of this design have been investigated previously. Use of direct heating on the membrane to eliminate heat transfer resistance through the feed fluid stream was experimentally tested by Hengl et al. [8]. Heating was delivered using an electrically resistive metallic membrane which would be impractical to use in a larger scale system. Energy efficiency performance was not measured. Chen et al. [9] used uniform solar flux to heat the feed stream by placing a solar absorbing surface above the feed stream. This method still experienced heat transfer resistance through the fluid stream, but captured the idea of integrating solar collection and desalination into one unit.

The feature that strongly distinguishes the present system from others developed in the past is the solar absorbing membrane 12 that sits below the water layer. The membrane can be a dyed single sheet that absorbs solar energy near the MD pores, or a composite membrane with a hydrophilic polymer such as polycarbonate or cellulose acetate, layered on top of a standard MD membrane material, like Teflon (PTFE).

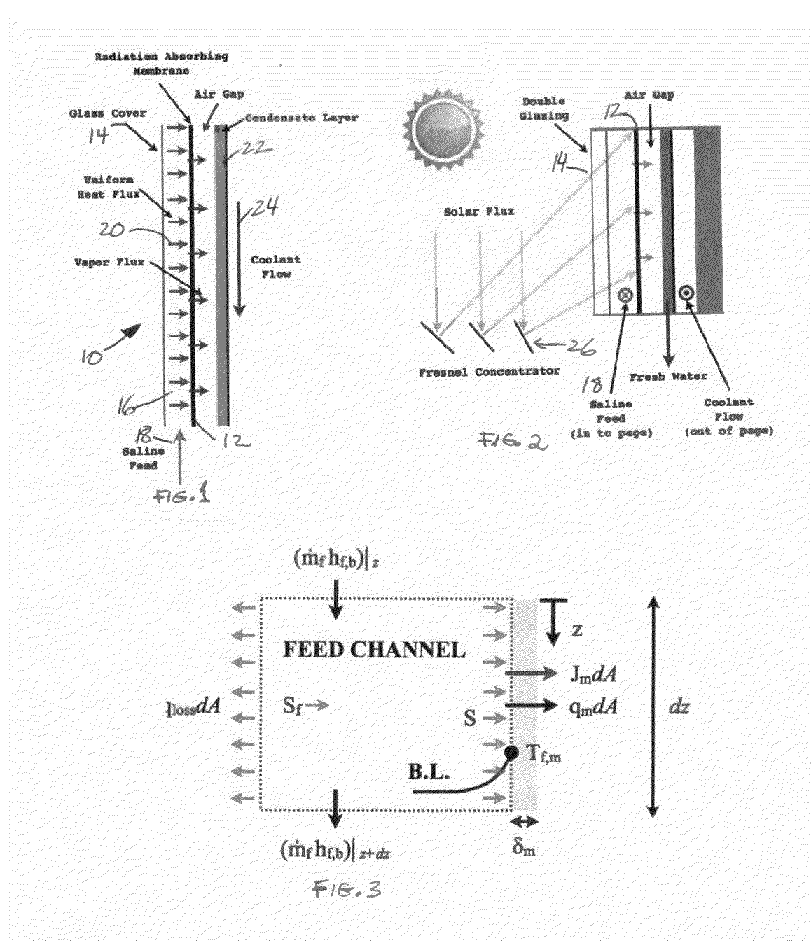

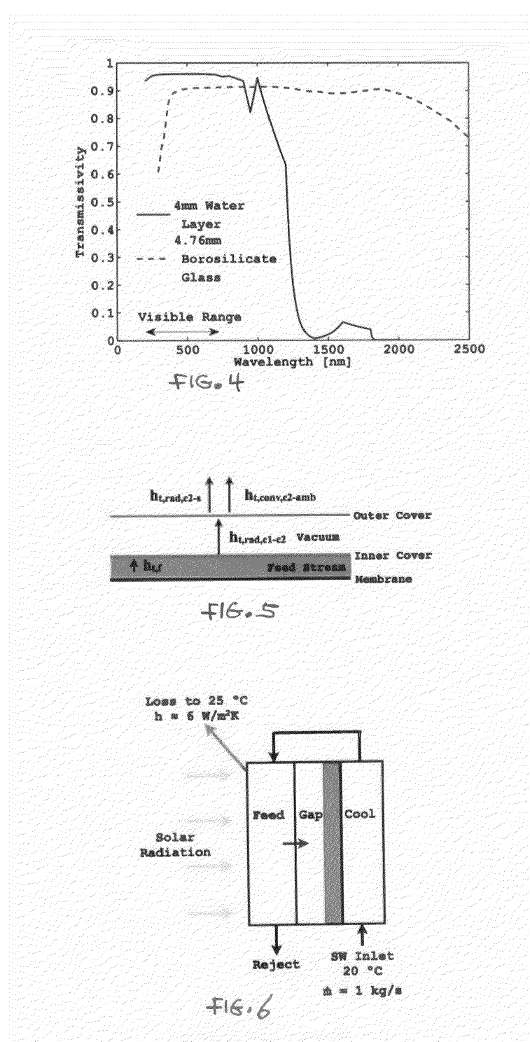

The membrane distillation portion of the system disclosed herein was modeled using equations from Summers et al. [10]. However, in a directly heated system there is no external heat input and the energy enters at the membrane surface. Since that surface is exposed to the environment, there are also losses. A control volume of a differential portion of the saline feed channel for this case in shown in FIG. 3.

Without a solar radiation input, the energy and mass balance of the fluid flowing through differential element remains the same as for any other MD system [10]. Previous work [17] assumes that the water acts as part of the cover system, and therefore no energy is absorbed in the water layer. However, while solar radiation is primarily absorbed at the membrane, the bulk feed stream does absorb a non-negligible amount of solar radiation, denoted by the variable S_{ƒ}. Equation 1 details the energy balance in the feed stream and membrane:

SdA=−q_{ƒ}dA+[Jₘ(h_{ƒg}+h_{ƒ,m}−h_{ƒ,b})+qₘ]dA (1a)

where the subscripts f, b and f, m are the feed are the bulk fluid and membrane on the feed side. qₘ is the conductive heat loss through the membrane, and J m is the vapor flux. Consolidating and collecting terms. Equation 1a shows that the solar input S is distributed among sensible heating of the feed stream, qƒ, energy to evaporate the liquid; and conductive losses through the membrane, respectively. Equation 1b accounts for the absorption of solar radiation into the feed stream.

m_{ƒ}dh_{ƒ,b}=[−q_{ƒ}+S_{ƒ}]dA (1b)

The temperature difference between the feed in the bulk stream and at the membrane surface can be found using the heat transfer coefficient h_{i,ƒ} between the bulk and membrane where heat flowing from the membrane to the bulk increases the temperature of the bulk stream over the length of the module as described in Eq. 2:

−q_{ƒ}dA=h_{t,ƒ}dA(T_{ƒ,m}−T_{ƒb}) (2)

The quantity S is determined by the transmission characteristics of the cover system. Since fluid flows over the absorber plate this fluid becomes an additional material in the cover system, attenuating the energy that reaches the absorber.

A system of two covers was described by Duffie and Beckman [1] which would account for incidental reflections between covers; however, a good approximation for most solar collectors is that transmission through to the next cover is a fraction of what is transmitted through the previous cover [1]. This is described by Eq. 3 with the entry angle of the light into the next cover being the exit angle of the previous cover.

τ₂=(1−ρₓ)(1−α_{z})τₖ (3)

αand ρare the fractions of energy lost by absorption and reflection, respectively, τis what is transmitted.

The water layer below the second cover acts as an additional cover. Reflection through the water is a function of the entry angle of a beam of light that exits the glass above it.

n_{gl} sin(θᵢₙ)=n_{w}, sin(θₒᵤₜ) 4)

The perpendicular and parallel components of reflection are defined by Eq. 5 and can be used to find the total reflectivity of the water layer in Eq. 6.

$$\begin{matrix}{r}_{\vert \vert} = \frac{{tan}^{2} ( {θ}_{out} - {θ}_{in} )}{{tan}^{2} ( {θ}_{out} + {θ}_{in} )} & ( 5 a ) \\ {r}_{⊥} = \frac{{sin}^{2} ( {θ}_{out} - {θ}_{in} )}{{sin}^{2} ( {θ}_{out} + {θ}_{in} )} & ( 5 b ) \\ ( 1 - {ρ}_{w} ) = \frac{1}{2} ( \frac{1 - {r}_{⊥}}{1 + {r}_{⊥}} + \frac{1 - {r}_{\vert \vert}}{1 + {r}_{\vert \vert}} ) & ( 6 )\end{matrix}$$

where p_{w} is fraction of beam light reflected from the surface of the water, and r₁ and rᵢ are the parallel and perpendicular components of reflectance, respectively. The loss due to absorptivity of the water layer is slightly more complicated. The glass glazings have a relatively constant extinction coefficient in the visible and near infrared where most solar radiation occurs. The extinction coefficient is related to the amount of radiant energy that gets absorbed per unit thickness and is a function of wavelength as described by Eq. 7:

$$α ( λ ) = 1 - exp [ \frac{- {K}_{ext} ( λ ) d}{cos ( {θ}_{out} )} ] \qquad ( 7 )$$

For water, the extinction coefficient varies in the range of solar radiation wavelengths [11]. FIG. 4 shows the transmissivity of water [11] using Eq. 6 and 7 compared to borosilicate glass, which is a common glazing material in solar collectors [12].

However, most solar energy that makes it through the atmosphere occurs at wavelengths below 1500 mn. To simplify the model to use one extinction coefficient for the water layer, a power-weighted average is used.

While the extinction coefficient is not related to power linearly, the absorptivity due to the extinction coefficient (Eq. 7), or the total power attenuated at a specific wavelength, is the absorptivity multiplied by the input power at that wavelength. The power-averaged absorptivity (Eq. 8) is used directly in the model instead of calculating it from a single extinction coefficient (as can be done for a glass glazing panel using Eq. 7).

α_{w}=ƒ₀^{∞}α(λ)I_{y}(λ)dλ/ƒ₀^{∞}rᵣ(80 )dλ (8)

where Iᵣ is the irradiance in W/m² nm. The irradiance can be approximated by using Planck's Law of emission from a black body in a vacuum [11], where the sun is approximated as a black body radiating at 5762 K [1].

$${I}_{r , bl} ( λ ) = {\frac{2 {h}_{pl} {c}_{0}^{2}}{{n}_{niv}^{2} {λ}^{5}} [ exp ( \frac{{h}_{pl} {c}_{o}}{{n}_{air} {Ir}_{b} λ T} ) - 1 ]}^{- 1} \qquad ( 9 )$$

This then allows us to find the total transmissivity of the water layer. Using Eq. 3 the transmissivity of the full stack can be obtained and combined with the solar absorptivity of the membrane to obtain the transmission-absorption product. While the transmission-absorption product is a function of the reflectivity of absorber, the vast majority of opaque absorber materials are minimally reflective and obey the rule described in Eq. 10 [1].

(τα)=1.01τ_{stack}α_{α} (10)

Using Equation 10 and breaking down τ Stack into its components for a collector with two glazings, c₁ and c₂, the solar absorption of the system can be calculated.

S=1.01τ_{c1}τ_{c2}τ_{w}αₘ (11a)

S_{ƒ=}1.01τ_{c1}τ_{c2}α_{w} (11b)

As with any solar collector the heated surface is exposed to the environment in order to collect solar energy. This results in a certain heat loss along the length. The heat loss through a cover system has been described in detail [1] as well as in previous work by the inventors [13]. The loss through the top is a combination of heat transfer from the feed water through the cover system and to the environment. Heat transfer modes are shown in FIG. 5.

The loss model further approximates the glass covers as opaque to thermal radiation from low temperature sources, and all energy received from radiation is absorbed and re-radiated at the temperature of the cover. Since the thermal radiation from the top cover sees the sky, it is lost to a sky temperature of 4° C. and the convective loss is to an ambient air temperature of 25° C. These conditions are typical of a desert environment on a clear day [14]. Typically, sky temperature is relatively unimportant for calculating collector performance [1]. However, this may become important as the module can run near 90° C. and radiative loss becomes a higher percentage of the total loss to the environment. Convective loss is determined by known correlations for forced convection over a flat plate [15] and an ambient wind speed of 4 m/s. To minimize loss to ambient air, the characteristic length of flow over the collector can be kept small by spacers that break up the wind along the length.

A uniformly solar heated MD system can be used in different cycle configurations. The simplest configuration is the module itself, which accepts cool saline water at the coolant inlet, and produces fresh water and brine reject at an elevated temperature. FIG. 6 shows this configuration.

Energy efficiency was tested by modeling the complete cycle. Lessons on optimal module designs from previous work [10] were applied to the baseline design for modeling the current system. Table 2 shows baseline operating conditions.

TABLE 2
Module Geometry

| | |
|---|---|
| Effective Length, L | 145 m |
| Width, w | 0.7 m |
| Channel Depth, d_{ch} | 4 mm |
| Air Gap, δ_{gap} | 1 mm |

Operational Parameters

| | |
|---|---|
| Mass Flow, \dot{m}_{f}, \dot{m}_{c} | 1 kg/s |
| Seawater Temperature, T_{SW,in} | 20° C. |

Membrane

| | |
|---|---|
| Membrane Dist. Coeff., B | 16 × 10⁻⁷ kg/s |
| | m² Pa |
| Porosity | 0.8 |
| Thickness | 200 μm |
| Conductivity | 1.2 W/m K |

Solar Collection

| | |
|---|---|
| Irradiation | 850 W/m² |
| Concentration Ratio | 1 |
| Glazing Separation | 20 mm |
| Glazing Thickness | 2 mm |
| Glazing Emissivity | 0.8 |
| (τα) Product | 0.7 |

Under these conditions, pressure drop in the flow direction is between 3.5 and 4 atm. For comparison, the liquid entry pressure of a moderately hydrophobic membrane with a contact angle of 120° and a pore diameter of 200 nm is around 6.6 atm, allowing the membrane to withstand such hydraulic pressures even if it contains pores that are larger than the mean pore diameter.

The measure of energy efficiency for this device will be the gained output ratio, or GOR. It is the ratio of the amount of heat to needed to evaporate the product water to the actual heat input for the cycle. As this device relies on solar energy, the GOR can be calculated in two ways: The heat input can be taken to be the incident solar radiation, thereby accounting for all the losses in the solar collection step, which for systems that use external solar collectors is captured by the collector efficiency. The heat input can be taken to be the energy provided to the fluid, which excludes the collection inefficiency and heat loss from the device. Both versions of GOR can be defined in terms of the problem parameters in Equation 12

$$\begin{matrix}{GOR}_{1} = \frac{{\dot{m}}_{p} {h}_{fg}}{IA} & ( 12 a ) \\ {GOR}_{2} = \frac{{\dot{m}}_{p} {h}_{fg}}{( S - \overline{{q}_{loss}} ) A} & ( 12 b )\end{matrix}$$

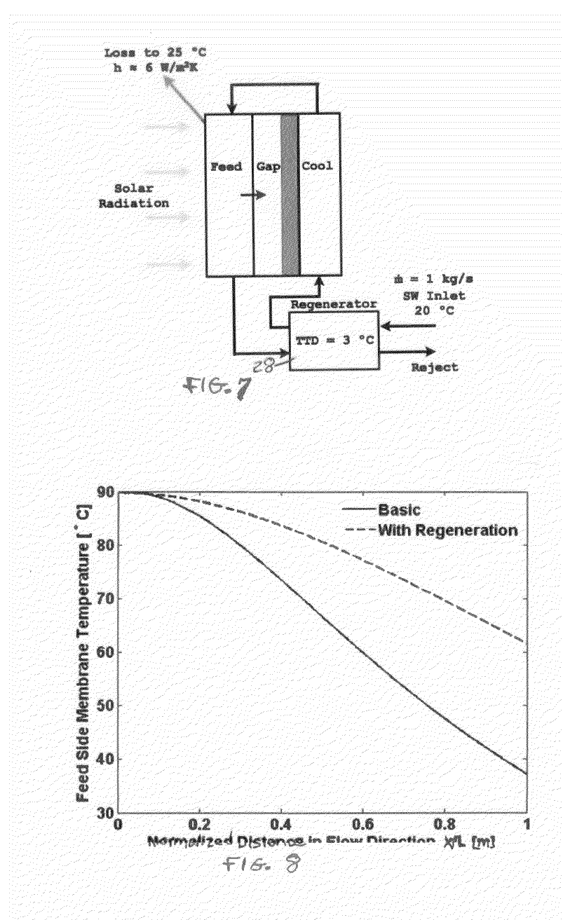

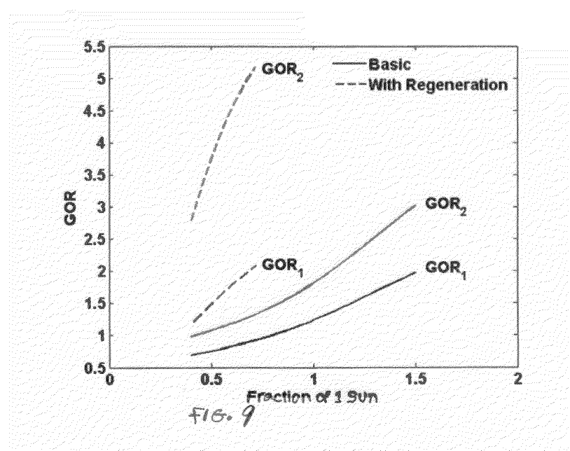

One sun represents 850 W/m², the daily mean radiation for summertime in a desert climate. The system was modeled at a variety of percentages at that amount. When the heat input was taken to be the incident solar irradiation, GOR for this system was on the order of 1, which is in line with existing solar desalination technologies. When the heat input was taken to be the heat absorbed by the fluid the GOR can approach three, which is competitive with commercial MD systems [16]. In this cycle, the feed side membrane temperature varies a great deal and goes quite low, as the coolant inlet is fixed at the cold seawater temperature. As a result, the potential for evaporation is reduced and high concentration ratios are required to achieve good performance as shown in FIG. 9. If the temperature of the membrane was higher and more even over the length, the potential for evaporation would be higher and performance improves for the same solar heat input. This is accomplished by using a recovery heat exchanger 28, as shown in FIG. 7.

The temperature over the module length is not necessarily flatter, but higher overall, as shown in FIG. 8. Most of the heat recovery in the system is done in the heat exchanger. This, however, comes at the cost of additional losses, as the hotter feed fluid is exposed to the environment.

FIG. 9 shows how the energy efficiency of this system varies with heat input. Overall the system with regeneration performs better for a given amount of energy input, especially when the heat input to the fluid is used as a basis for GOR (GOR₂). This has the distinct advantage of eliminating the need for concentrating collectors, and performing better during low solar insolation periods, such as dawn and dusk. Since losses make up a greater fraction of the heat input, and are not linearly related to temperature, the difference between the two definitions of GOR becomes more apparent.

A novel membrane distillation system using direct radiant heating of the membrane has been described. This device shows promise in improving solar powered desalination in a simple, effective single or two-piece device. It has the advantages of integrating solar collection into a single device, and delivering heat directly to the source of evaporation, reducing temperature polarization, and increasing vapor flux. A simple liquid-liquid heat exchanger can be added to improve performance, allowing the device to function well during low insolation periods. This device has the potential to achieve performance that exceeds both that of existing solar stills and that of more complex solar powered MD systems.

The numbers in square brackets refer to the list of references included herewith. The contents of all of these references are incorporated herein by reference in their entirety.

It is recognized that modifications and variations of the present invention will be apparent to those of ordinary skill in the art and it is intended that all such modifications and variations be included within the scope of the appended claims.

### REFERENCES

### [1] J. A. Duffie, W. A. Beckman, Solar Engineering of Thermal Processes, Wiley, Hoboken, N.J., 2006.

[2] S. Parekh, M. M. Farid, J. R. Selman, S. Al-hallaj, Solar desalination with a humidification-dehumidification technique . . . a comprehensive technical review, Desalination 160 (2004) 167-186.
[3] R. B. Saffarini, E. K. Summers, H. A. Arafat, J. H. Lienhard V. Economic evaluation of stand-alone Solar powered membrane distillation systems, Desalination (2011), Submitted For Publication.
[4] F. Banat, N. Jwaied, M. Rommel, J. Kosebikowski, M. Wieghaus, Desalination by a “compact SMADES” autonomous solar-powered membrane distillation unit, Desalination 217 (2007) 29-37.
[5] H. E. Fath, S M Elsherbiny, A. A. Hassan, M Rommel, M. Wieghaus, J. Koschikowski, M. Vatansever, P V and thermally driven small-scale, stand-alone solar desalination systems with very low maintenance needs, Desalination 225 (2008) 58-69.
[6] E. Guillen-Burrieza, J. Blanco, G. Zaragoza, D.-C. Alarcon, P. Palenzuela, M. Ibarra. W. Gernjak. Experimental analysis of an air gap membrane distillation solar desalination pilot system, Journal of Membrane Science 379 (2011) 386-396.
[7] X. Wang, L. Zhang, H. Yang, H. Chen, Feasibility research of potable water production via solar-heated hollow fiber membrane distillation system, Desalination 247 (2009) 403-411.
[8] N. Hengl, A. Mourgues, M. Belleville, D. Paolucci-Jeanjean, J. Sanchez, Membrane contactor with hydrophobic metallic membranes: 2. study of operating parameters in membrane evaporation, Journal of Membrane Science 355 (2010) 126-132.
[9] T.-C. Chen, C.-D. Ho, Immediate assisted solar direct contact membrane distillation in saline water Desalination, Journal of Membrane Science 358 (2010) 122-130.
[10] E. K. Summers, H. A. Arafat, J. H. Lienhard V, Energy efficiency comparison of single-stage membrane distillation (MD) desalination cycles in different configurations, Desalination 290 (2012)54-66.
[11] J. R. Howell, R. Siegel, M. P. Mengue, Thermal Radiation Heat Transfer, CRC Press, New York, fifth edition, 2011.
[12] Y. Touloukian, Y. Ho (Eds.), Thermophysical Properties of Matter, volume 8, Thermal Radiative Properties: Nonmetallic Solids, Plenum Press, New York, 1972.
[13] E. K. Summers, S. M. Zubair, J. H. Lienhard V, Air-heating solar collectors for humidication-dehumidication desalination systems, Journal of Solar Energy Engineering 133 (2011) 011016-1-6.
[14] W. Underground, Weather History for Dhahran, Saudi Arabia. Online, 2011.
[15] J. H. Lienhard V, J. H. Lienhard I V. A Heat Transfer Textbook, Phlogiston Press, Cambridge, Mass., 3rd edition, 2006.
[16] G. Lange, G. van Gendt. F. Bollen, W. Heinzl, K. Zhao, T. G. Fane, Demonstrating solar-driven membrane distillation using Memsys vacuum-multi-effect-membrane distillation, in: Proceedings of the IDA World Congress on Desalination and Water Reuse, Perth, Australia, Sep. 5-9, 2011, International Desalination Association. Topsfield, Mass. 2011.
[17] E. K. Summers and J. H. Lienhard V. “A novel solar-driven air gap membrane distillation system,” Desalination and Water Treatment, vol. 31, no. 7-9, pp. 1344-1351, February 2013.

What is claimed is:

1. Membrane distillation system comprising:
a solar radiation absorbing porous membrane positioned to receive solar radiation to heat the membrane;
a transparent cover spaced apart from the membrane to form a channel through which a saline feed stream flows;
a condensation structure spaced apart from an opposite side of the porous membrane forming an air gap channel therebetween; and
means for providing coolant flow along an outside surface of the condensation structure whereby distilled water will condense on the condensation structure for collection from the air gap channel.

2. The system of claim 1 wherein the membrane is dyed to enhance solar absorption.

3. The system of claim 1 wherein the membrane is a composite structure of a hydrophilic polymer disposed on a membrane material.

4. The system of claim 3 wherein the membrane material is PTFE (Teflon).

5. The system of claim 1 further including a recovery heat exchanger to heat the feed stream.

6. The system of claim 1 wherein the transparent cover comprises double glazing with or without a vacuum therebetween.
